(19) United States
(12) Patent Application Publication
(10) Pub. No.: US 2007/0143229 A1
(43) Pub. Date: Jun. 21, 2007

(54) Secure data exchange, notably of certified for factoring

(76) Inventors: Michel Delahaigue, Ableiges (FR); Marc Abbati, Levallois Perret (FR)

Correspondence Address: GENERAL ELECTRIC CO.;GLOBAL PATENT OPERATION, 187 Danbury Road, Suite 204, Wilton, CT, 06897-4122, US

(21) Appl. No.: 10/596,924

(22) PCT Filed: Dec. 22, 2004
(86) PCT No.: PCT/US04/42954

§ 371 Date: Jun. 29, 2006

(30) Foreign Application Priority Data
Dec. 31, 2003 (FR) 0315626

(51) Int. Cl. G06Q 99/00

(52) U.S. Cl. 705/72

(57) ABSTRACT

The invention relates to an information processing system, including:
a network interface (50), suitable to initialize a connection with a distant station (91),
a memory manager (41), suitable to create and maintain a memory space dedicated to a distant station (91), for the data exchange between the system and this distant station (91), and
a session manager (41), responsive to an initialization of a connection with successful identification for opening a session of distant station, associated with a single token, and with a memory space dedicated to the distant station in the memory manager, the data exchanges with the distant station during a session being conditioned by the presence of the associated token.

The invention concerns the secure exchange of certified data, notably over a wide-area network like the Internet.

In a process such as factoring, it is necessary to establish an exchange having legal value between the factor and his clients, the vendors, who have themselves already established invoices for their own clients, the buyers.

Traditionally, the exchange in question is established on paper. But it is manifestly desirable to render it as efficient as possible and, therefore, to computerize to the maximum, while retaining the fixed character, the legal value, and also the convenience of use. As for the latter point, the convenience of use, a network like the Internet is very convenient; on the other hand, with the Internet, it is difficult to adhere to the other imperatives.

The exchange of online files on the Internet is today quite well mastered. The situation is different for interactive operations, like an online entry, where it is a question of establishing remotely a large-sized document, which is intended to have a fixed character and, a fortiori, a legal value.

The present invention improves that situation;

According to one aspect of the invention, a computer system is proposed, which comprises:
a network interface, capable of initializing a connection with a remote station,
a memory manager, capable of creating and maintaining a memory space dedicated to a remote station, for the exchange of data between the system and that remote station, and
a session manager, reacting to a connection initialization with successful identification by opening a remote station session, associated with a single token and a memory space dedicated to the remote station in the memory manager,
the data exchanges with the remote station in the course of a session being conditioned by the presence of the associated token.

In an embodiment, the memory manager is set up to define the said memory space as software object, associated with the identifier and with the single token. A container can then be provided, capable of storing a correspondence between software objects and the single tokens assigned to them.

For its part, the session manager can be set up, after successful identification, to retrieve a software object corresponding to that identification and, if it exists, to offer the remote station, as first exchange with token, the option of resuming a task on that software object or of abandoning it in order to create a new one associated with a new task. In one particular application, the tasks offered a remote station are: a data entry function, an entered data validation function and at least one post-processing function after validated entry. In the case of a remote entry application, offered to the remote station, the dedicated memory space is allocated to the temporary storage of entered data awaiting validation. Thus, the session manager can operate by sending the remote station an entry form, with wait for a return of the completed form, accompanied each time by the corresponding single token. More precisely, the entered data can be invoice data remotely submitted to a factoring entity by a remote vendor station.

Furthermore, the session manager can be set up at least to make the function of validation of invoices entered for submission to factoring subject to a certification based on a personal code (PIN) by the qualified operator on the vendor side.

According to another aspect of the invention, the computer system includes a generator of a native printing file, with authentic font printing, drawn from a coherent set of data present in the system, for example, in an internal server, and a document manager capable of printing account-oriented data from that native file in different formats.

In particular, the document manager can comprise:
a native file accessor, capable of reacting to a document identifier by selecting a corresponding portion of the native file, and
at least two printing/display constructors, capable of cooperating with the native file accessor in order to construct two display/printing files, corresponding to the same printable content, those two display/printing constructors operating on different file formats.

This makes it possible to use, internally and at the vendors, documents directly comparable, printed and/or on the screen.

Other characteristics and advantages of the invention will be apparent on examination of the detailed description below and of the attached drawings, in which:

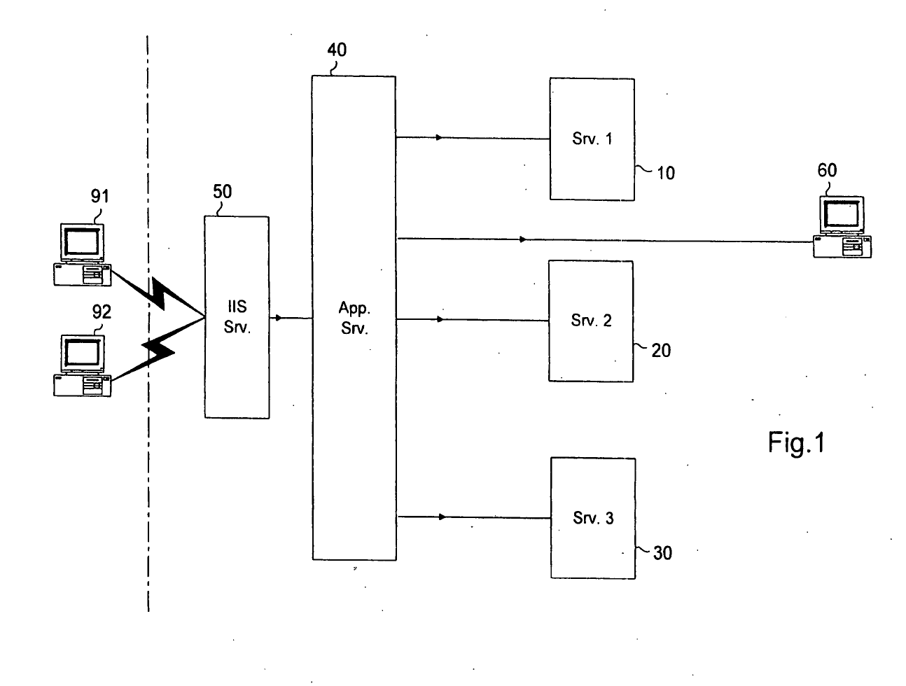

FIG. 1 is a general diagram of a computer system usable notably for factoring, with Internet connection,

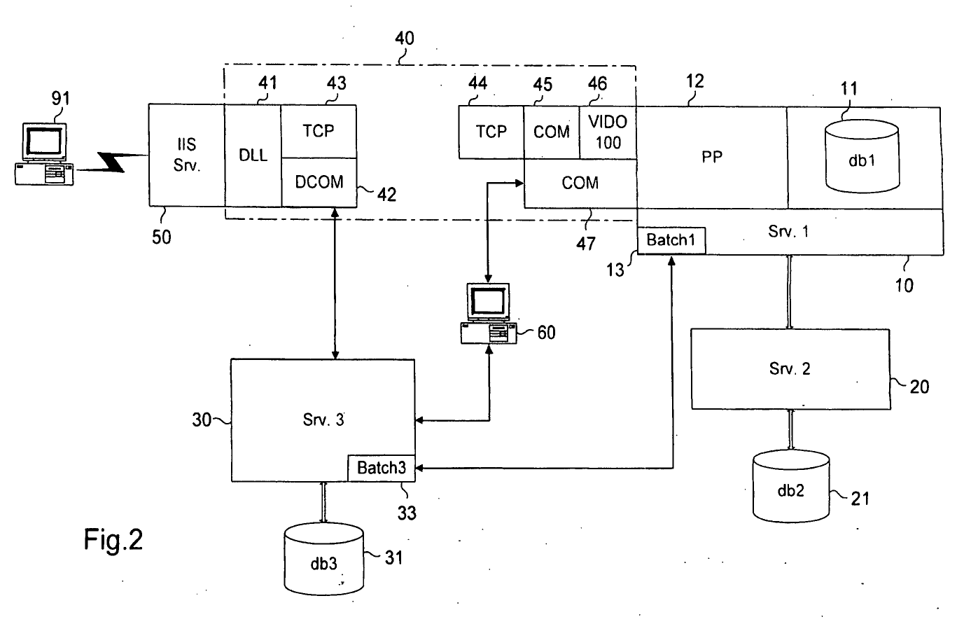

FIG. 2 is a more detailed structural diagram of the system of FIG. 1,

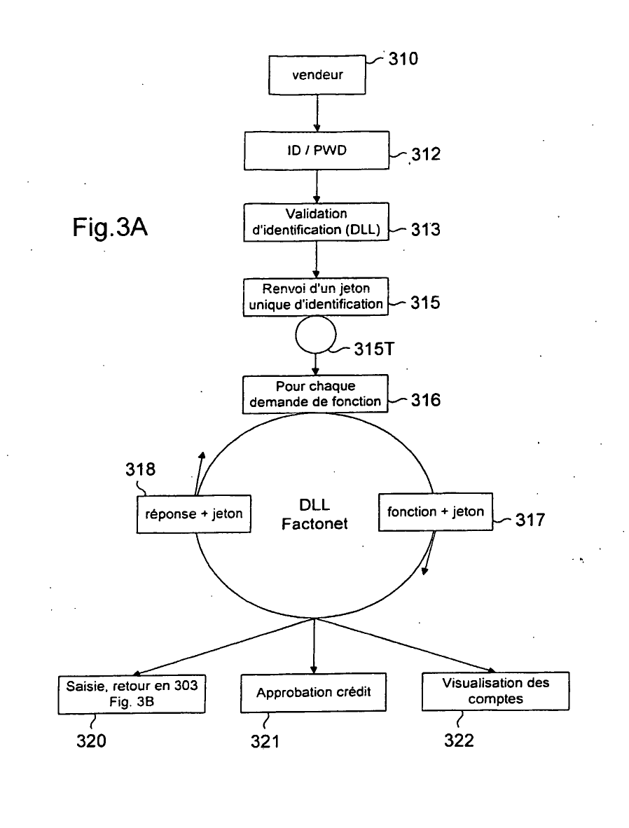

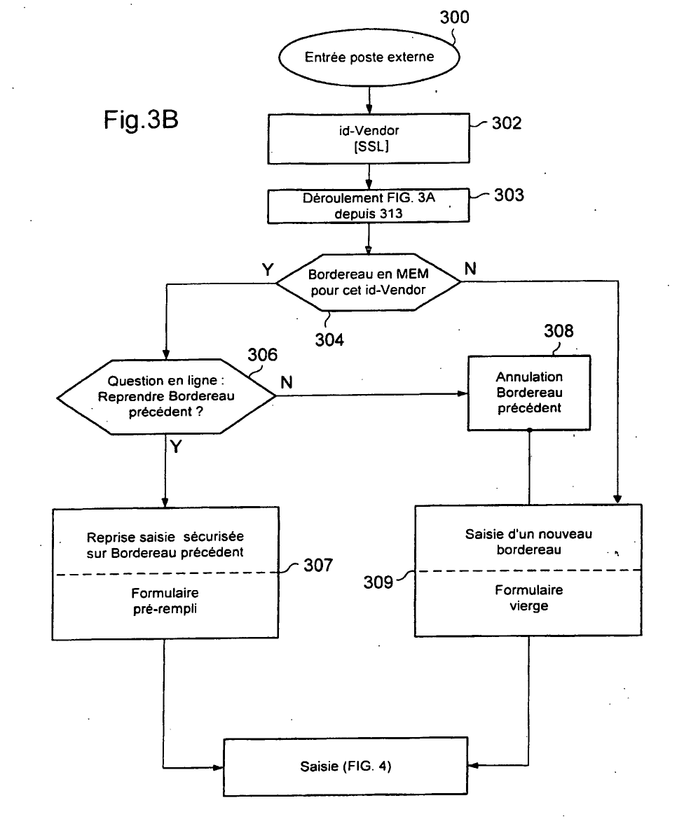

FIG. 3A is a flow chart of the input of an external station in one of the possible modes of the invention, in a more material view,

FIG. 3B is a flow chart of the input of an external station in the “online entry” mode, in a functional view,

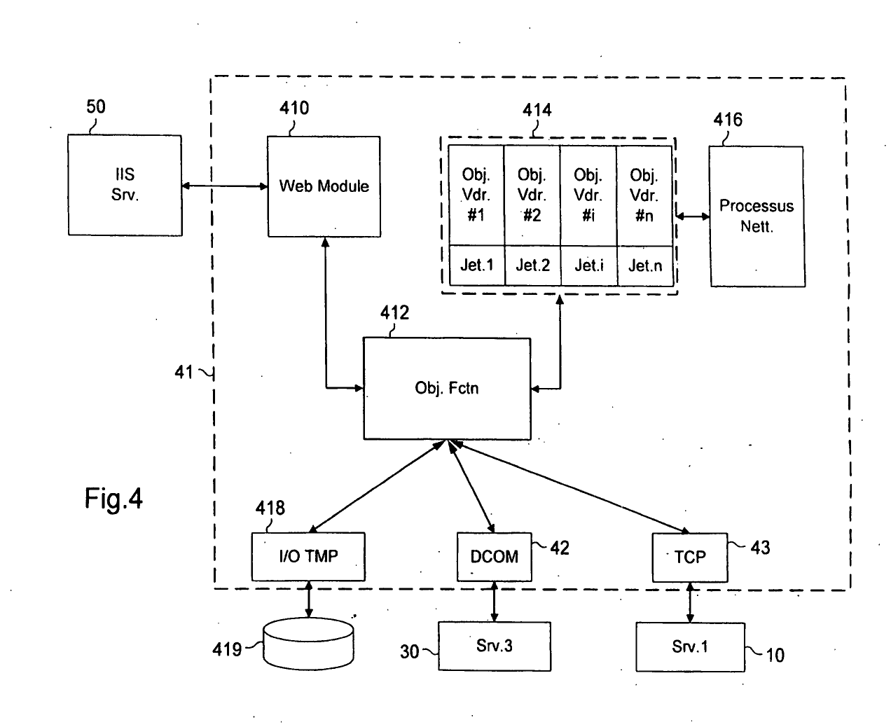

FIG. 4 is a more detailed structural diagram of a server of FIG. 2,

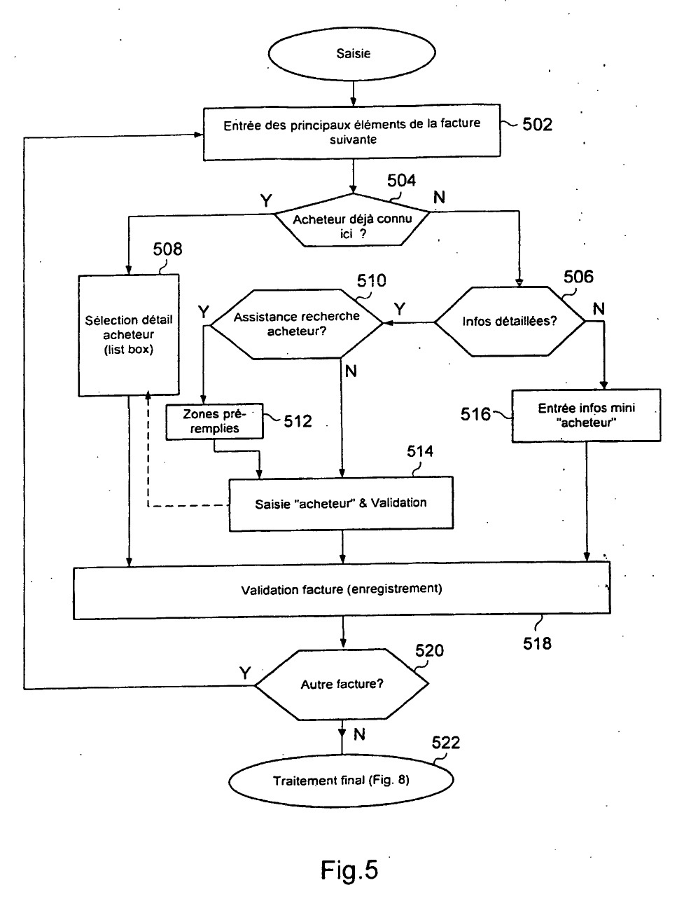

FIG. 5 is a diagram of processing of the “online entry” mode of FIG. 3B by a server of FIG. 2,

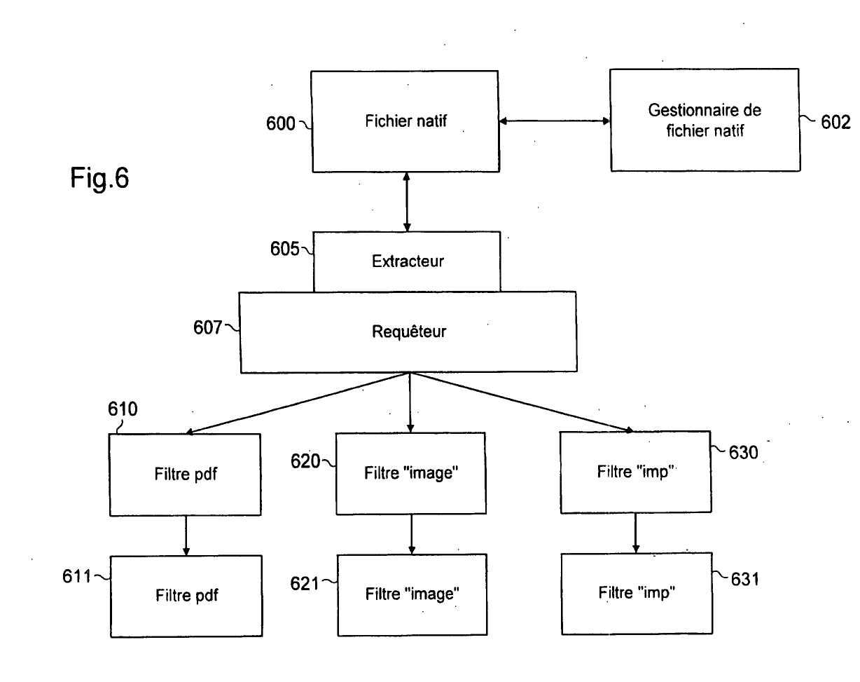

FIG. 6 illustrates the use of native printing files for different display/printing formats in a system according to one of the preceding figures,

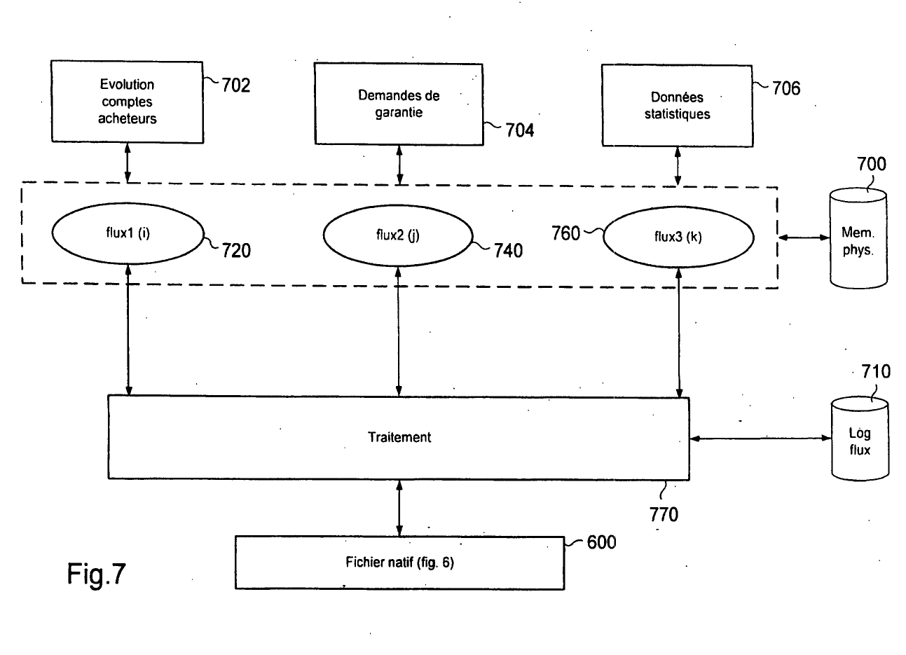

FIG. 7 illustrates the operation of the system of one of FIGS. 1 to 4, in the example of elaboration of a monthly statement, with preparation of a native printing file according to FIG. 6,

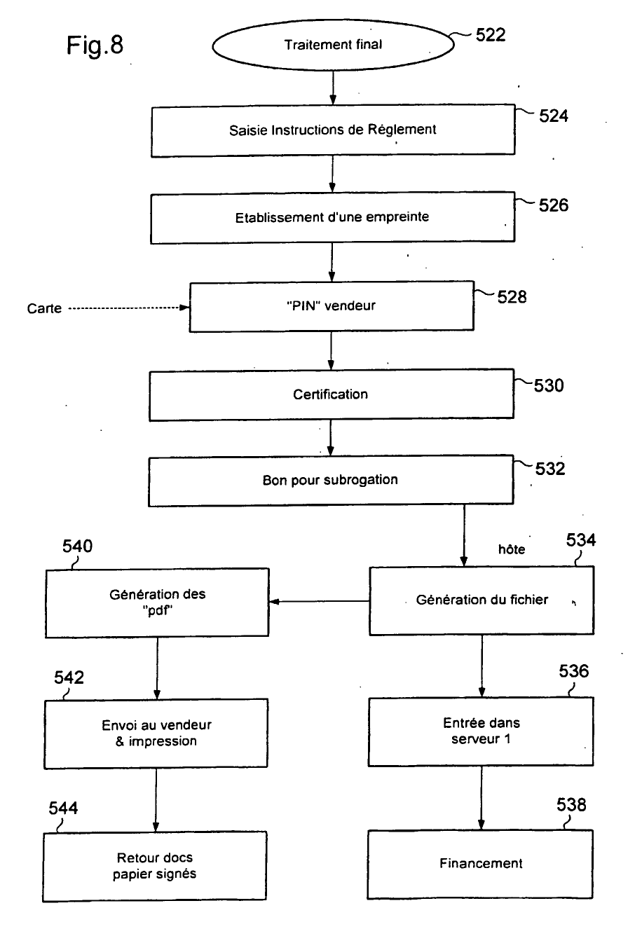

FIG. 8 is a flow chart illustrating the operation of the system according to one of FIGS. 1 to 4 in another example, which is the elaboration of a document with legal value called “subrogation receipt,” and

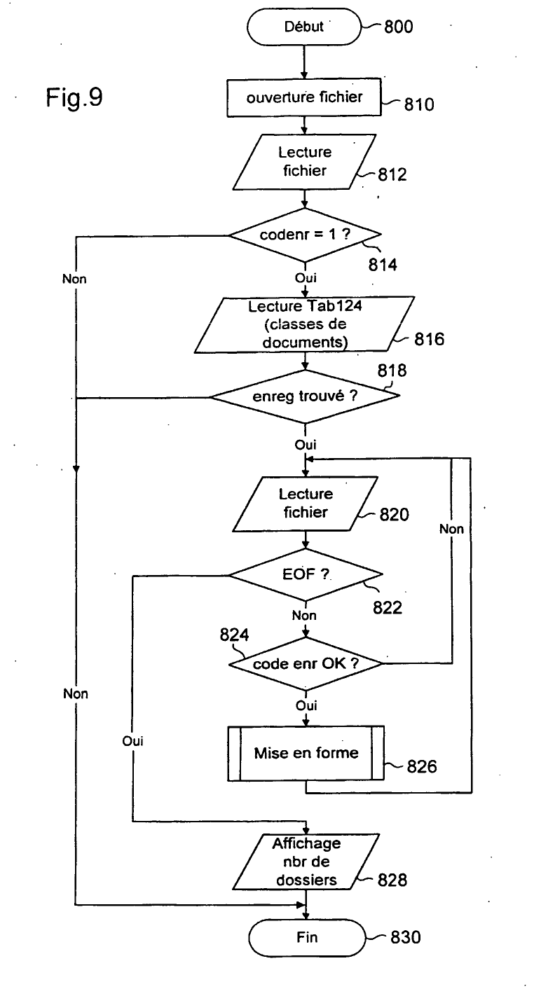

FIG. 9 is a flow chart illustrating the generation of a particular type of printing file.

The drawings and description below essentially contain elements of fixed character. They may therefore serve not only to facilitate understanding of this invention, but also to contribute to its definition, as the case may be.

The present description may introduce elements subject to intellectual property and/or copyright protection. The holder of the rights has no objection to the identical reproduction by anyone of this patent or of its descriptive part, as it appears in the official records. For everything else, all rights are totally reserved.

Although it is more generally applicable, the invention will be described below within the context of a particular example, which is factoring, in the broad sense of the term.

Factoring consists of having an entity (“vendor”), which issues invoices to its customers (“buyers”), delegate management of those invoices to a thirty entity (“factor” or “host”).

“Invoice management” comprises a priori:
taking charge or “entry” of the invoice by the provider, in the form of the required identifications of the invoice, of the parties concerned (vendor and buyer) and at least of the overall sum billed each time, accompanied, in principle, by a term of payment,
collection of payment thereof, possibly within agreed times, if need be with constraint measures against defaulting debtors,
“consultation of buyer accounts,” that is, the account rendered to each vendor, as far as it is concerned, on the execution of that collection, buyer by buyer, in the form of an overall sum and/or itemized, and
management by the vendor of the “user profiles,” that is, of the access accounts according to vendor (commercial access or access for a security deposit).

It is to be understood that, for the host, one and the same entity can be both vendor and buyer.

These two roles are, of course, compartmentalized, insofar as necessary.

But “invoice management” can also embrace:
the possible opening of guarantee lines to vendors according to the amounts due them,
for that purpose, evaluation of the debt portfolio managed by the provider for each of the vendors,
the “list of latest approvals” corresponding to the guarantee lines,
the supply to each vendor of statistics on its activity, from the viewpoint of billings and their settlement.

Aside from that, each vendor can exchange messages, by e-mail, for example, with its manager or “contact” at the host's [location] (the factor, in the example). It is to be observed, however, that the participants on both sides are not necessarily the same, depending on the function considered. For example:
the entry of invoices is an accounting operation,
on the other hand, the demand for guarantee lines is a financial management operation which, at least on the vendor's side, will in principle introduce a “decider.”

The use of these functions involves a developed and secure computer system on the provider's side.

It is, of course, important, at least in part, for the said functions to be fulfilled by telecommunications between the vender and the provider's computer system. For that purpose, it is possible to use:
Minitel type links (registered trademark), but the capacities of which are rather limited;
specialized telecommunication lines, which are not generally applicable to all the customer vendors of the provider,
Internet links, which are more powerful, but raise different problems, notably regarding security and confidentiality.

The present invention is notably intended to improve and increase the functions attainable by telecommunications, especially but not exclusively over the Internet.

Thus, it is aimed notably at enabling each vendor so desiring, without excessive investment, to:
enter on line the invoices reassigned, that is, entrusted to the factoring provider;
consult not only its vendor account, but also the list of buyers concerned;
recover a printable computerized control version of all the accounting documents and attachments required;
exchange electronically with the factoring host documents having legal value, such as the so-called “subrogation receipts,” with, as an option, the possibility of automatic management of releases of funds, which are then advanced to the vendor.

Reference is now made to FIG. 1. A host computer system applicable to factoring can consist of a principal server 10, (Srv1), associated with different other servers, here a server 20 (Srv2), and a server 30 (Srv3).

An application server can also be provided, enabling internal stations to access data. Station 60 is, for example, an internal operator station which serves to manage vendor accounts.

An Internet server (IIS Srv) 50 enables external stations such as 91 and 92 to access the restricted part of the information concerning them. It will be described later on how that restriction is made.

Server 10 contains, for example:
the data relating to bookkeeping, notably, the list of invoices and sundry operations,
the functions enabling the vendors to consult their accounts,
the follow-up of bills outstanding, taking into account payments of buyers, received by the factor, on vendors' invoices.

Server 20 contains, for example, the guarantee claims by vendors, in accordance with buyers' bills outstanding and management of available assets, as well as reference tables, such as foreign currency tables, countries and operating codes.

Server 30 contains image information and useful statistical information, as well as the functions relating to online entry of invoices.

FIG. 2 illustrates an example of hardware architecture corresponding to the system of FIG. 1.

This FIG. 2 reveals the mass memories (hard disks, for example) 11, 21 and 31, respectively associated with servers 10, 20 and 30.

The structure is somewhat different from that of FIG. 1, in the sense that the functions of the application server 40 of FIG. 1 are now contained within the broken line frame 40, which comprises:
on the side of the Internet server 50, an online services application 41 (called “Factonet.d11”), with a communication interface 42 (DCOM) with server 30, and another communication interface 43 (TCP) which communicates with server 10;
on the side of server 10, a TCP stack 44, followed by the general communication interface 45 of that server 10, and then a function 46 (called VIDO100) forming the counterpart of the online services application existing in server 30;
also on the side of server 10, a communication layer 47, enabling the internal stations, like 60, to access server 10.

Thus, the exchanges involving the evolution of data already established (certified on vendor's side) can be produced directly between the Internet server 50 and server 10. On the other hand, in the example described the exchanges of data to be certified are treated differently, by means of server 30, as will be seen below in detail.

FIG. 2 also shows that server 10 is provided with a procedural programming environment 12 (PP) based, for example, on Cobol language. That environment is capable of treating objects in procedural form.

Reference is now made to FIG. 3.

In the example, the online entry of invoices, once completed, is going to be accompanied by a certified exchange which delegates to the factoring host the task of collecting the invoices listed. This certified delegation is called a “subrogation receipt.” It is a legal document, which may be confirmed by the separate transmission of a duly signed paper document. It is, of course, essential that the online entry and the paper document should be rendered substantially identical insofar as possible. And this raises, first of all, the problem of secure online entry of the imposing document that generally constitutes the subrogation receipt. In fact, it is common to have some one hundred subrogated monthly invoices.

Applicant solved this problem by providing in a server, here server 30, a memory area dedicated to online entry for each of the vendors. When the subrogation receipt is completed and validated, the subrogated invoices pass into server 10 through an asynchronous grouped communication between a batch module 3 of server 30 and a batch module 1 of server 1. Server 10 and server 20 can then make use of these subrogated invoices.

Applicant was concerned about defining a stable identification between the remote “vendor” station, which could be that of the issuer of the invoices, and the host computer system. It turned out that the Internet address (or other network address) is unsatisfactory, because vendor stations can be associated with a supplier of secure Internet access, which changes the Internet address dynamically, for example, on each connection.

Applicant solved that problem by using a multiple token system.

FIG. 3A illustrates the entry into a session of a vendor station, with a “material” view, that is, for the lower level aspects (token) of the connection.

At 310, the vendor accesses, here through the Internet, the host site, in the present case:

https://www.facto.fr/factonet

In operation 312, the vendor's operator supplies an identifier and a secured password (for example, by encryption called SSL or “Secure Socket Layer”). On the host side, in operation 313, a validation is made of the vendor's identification. This is done here through a “dll” type function, described for sake of convenience as DDL factonet. If the validation is positive, the DLL function creates and returns securely (for example, by SLL encryption) to the vendor, at 315, a single identification token, noted 315T.

This token can be calculated as a random function of the date, of the time and of a value ranging between 0 and 9999, for example, by preserving its uniqueness, as required, by an antidoublet mechanism in known manner. A token example is given 3ZBYEYBW04355865, in which the token is the concatenation of the result of a random function on the date (37BYEYBW), time (04:35) and a random value. Such a token, combined with the SSL encryption, conveniently supplies both good securization of transmissions and good isolation of the latter from one vendor to another. Those aspects were important in enabling Applicant to use an entry of online subrogated invoices.

Then (316), for each function request by the vendor station, such request (317), accompanied by the token 315T, is addressed to the factonet.dll function noted here 319, and the answer 318 is accompanied by the same token. The SSL encryption can be used, as previously. This function request can involve, for example, one of the following functions, which can be offered in menu:
the online entry in operation 320,
the credit approval in operation 321,
the display of accounts din operation 322.
Such a function request can take the form:
https://www.facto.fr/scripts/factonet.DLL/menu?jeton=<Jeton>

where the expression menu? designates one of the functions required by the vendor's operator, and where the expression <Jeton>represents the token.

FIG. 3B illustrates, in particular, the case of an entry function required by a vendor, as indicated in operation 320 of FIG. 3A. The entry of invoices and their certification do not pertain to the same person. Furthermore, interruptions, whether voluntary or not, can occur in entry.

Operations 310 and 312 of FIG. 3A correspond to operations 300 and 302 of FIG. 3B.

An entrant remote station (300) indicates (302) its id_vendor identifier in secured manner (SSL type communication). Operations 313 to 320 of FIG. 3 unfold. Thus, after validation of the vendor's identification (313) by the DLL function, a token is returned (315) securely to the server 50, that token playing the role of identifier of the current state of the vendor's session. If the vendor's operator requires the entry function (320), the server 50 transmits the vendor's identifier and the token to the server 30, who searches (304) whether an entry statement started at a previous session, exists in memory for that vendor. As a variant, the server 50 can be the one checking whether a statement is already present in memory. In case there is a statement started and not finished, the previous session and its state of progress have been identified in memory respectively by the vendor's identifier and a token. The remote user is then asked (306) to decide to resume that previous task (307) or to undertake a new one. In the latter case, the previous task can be cancelled and destroyed (308), and the user will undertake the entry of a new invoice statement (309). Of course, if the test 304 does not indicate the previous task, the user passes directly to 309.

This mechanism makes possible a satisfactory securization of entry, while totally avoiding for the user the need to resume if a session is interrupted, whether voluntarily or not. It will be observed that the data entered are totally stored directly at the host's.

FIG. 4 illustrates a mode of operation by tokens for Internet access. In this figure. an Internet server 50 is represented, comprising the DLL Factonet. application 41, with the communication interface 42 (DCOM) with server 30, and another communication interface 43 (TCP) which communicates with server 10. Application 41 is, in particular, described below.

Application 41 comprises a Web module 410 relating to server 50 on one side and a functions library 412, called function objects, on the other. The Web module calls the functions of that library. The Web module includes a distributor (or dispatcher) adapted to distributing on good communication interfaces the different function requests from vendors.

The Web module 410 validates the identification of a vendor and calls a function from the library 412, in order to calculate a token for a given vendor and a given session. The Web module 410 allocates the token calculated and returns it to the server 50. The Web module acts at that stage as a memory manager, set up to define a dedicated memory space, as software object, associated with the identifier and the single token. Thus, it creates a vendor object which makes it possible to store the history of a vendor's session, and records it on a disk 419 with temporary input/output, each vendor object including the vendor's identifier. Furthermore, the Web module temporarily stores in a container, which can be a table 414, each pointer of a vendor's object and its associated token. Thus, a token makes it possible to identify the session of the vendor corresponding to the vendor's object. In other words, the container stores a correspondence between software objects and single tokens allocated to them.

If the vendor's operator does not perform any action during a session for a given time, 15 minutes, for example, a cleaning process 416 takes place in order to destroy the corresponding token, the vendor's object pointer in table 414. The Web module also makes it possible to manage the repeated and not yet satisfied request of the vendors by sending a standby message to the vendor.

On a function request by the vendor's operator, the Web module uses a function of the library 412, in order to communicate that function request to the proper server:
if the vendor's operator asks for an online entry, the request will be communicated by the communication interface 42 (DCOM) to the server 30,
if the vendor's operator asks for a display of its accounts, the request will be communicated by the communication interface 43 (TCP), which communicates with the server 10,
if the vendor's operator asks for a credit approval, the request will be communicated by the communication interface 43 (TCP) to the server 10,

The function request is sent with the token of the vendor's current session. The answer returned to the Factonet DLL application 41 also includes the token of the session.

By way of generalization of FIG. 3B and in relation to FIG. 4, the Web module can, after identification of a vendor and creation of a token for the vendor's current session and starting from the container pointing to the vendor's objects stored, search whether the identifier of that vendor is located in a previous vendor object corresponding to a previous session. Thus, if the search does not turn up any vendor's object including the vendor's identifier, a new vendor's object is created for the new session and the Web module allocates the current token to that vendor's object. If the search results in locating a vendor's object including the vendor's identifier and the vendor's operator validates the creation of a new vendor's object for the new session, that vendor's object is created and the Web module allocates the current token to that vendor's object. The vendor's operator will not benefit from the vendor's object of the previous session, which may be destroyed. On the other hand, the vendor's operator can validate the recovery of the vendor's object stored in the container, so that the vendor's operator may resume and complete the previous session. In that case, the Web module allocates the current token to that vendor's object from the previous session.

The Web module acts here as a session manager, which is set up as follows: after successful identification, it searches for a software object corresponding to that identification and, if it exists, it offers the remote station, as first exchange with token, the possibility of resuming a task on that software object or of abandoning same in order to create a new one associated with a new task. This can be useful, notably, for remote entry.

FIG. 5 illustrates the processing of the request for an invoice entry to be subrogated on line at the vendor's by server 30 on demand of the Factonet DLL application 41 of FIG. 4.

The vendor's operator inputs the principal elements of the current entry invoice (502). The server 30 of FIG. 2 checks whether the buyer is already known, for example, in a table of buyers associated with the vendor entering the invoice (504).

If the buyer is already known, the vendor's operator can select from a list of buyers the details concerning that buyer (508), in order to establish an itemized invoice. Otherwise, the server 30 checks whether the vendor's operator has entered the detailed information concerning the buyer (506). If not, the server asks the vendor to enter the minimum information concerning the buyer (516); if so, the vendor is asked whether it wishes to have the buyer's search assistance (510). If assistance is required, the vendor's operator receives an entry window from the buyer with prefilled areas (512) and then completes the entry window with buyer information and validates the window (514). If assistance is not required, the vendor's operator receives an entry window from the buyer and the entry window with buyer information and validates the window (514). That information is retained by the server 30 on its disk. That window can be attached to the list of buyers of operation 508.

After operation 508, 514 or 516, the vendor's operator validates the invoice (518) by its registration and the server 30 can store it on its disk. During one and the same session the vendor's operator can enter and validate other invoices for the same customer or other customers (520), the diagram then resuming at 502. If no other invoice has to be entered (520), the server 30 executes the final processing of the invoice, as illustrated in FIG. 8.

FIG. 8 illustrates the final phase of certification of the elements entered, still in the example of a subrogation receipt.

Once the registered invoice is validated, the instructions concerning settlement of the invoice are entered by the vendor's operator (524). A printout is made (526) and the PIN (Personal Identification Number) code of the vendor inscribed on a vendor's card is entered (528). The certification card can, for example, be of the “Click and trust” type, guaranteed by a third party of confidence. The certification (530) of the invoice is made by the operator of the vendor if the latter can certify the invoice. If the vendor's operator is only qualified to enter such an invoice, certification of the subrogated invoice is made by another qualified representative of the vendor, after his identification by his card. The vendor's operator or the person qualified to certify the invoice and its subrogation gives his consent to subrogation of the invoice (532).

A general file of subrogated invoices is generated (534). It can serve as a basis for constructing a printing file, for example, in the PDF format (540), on the host's side. This file is sent to the vendor, who prints it (542). A qualified representative of the vendor then returns the signed printed document, for example, by standard fax or by mail. Thus, if need be, the legal document certified on line can thus be confirmed by separate transmission of a paper document bearing a standard written signature (544).

As an option, financing can be requested upon certification of invoices, as reminded by operation 538.

Similarly, the file containing the set of invoices entered and subrogated is sent from server 30 to server 10 through a communication 536, for example, in batches (batch 536). The subrogated invoices can then be processed by server 10. In brief, with the subrogated invoices the factoring host can, in known manner, use different processings for itself and for the operator of the vendor, its customer.

Other types of exchanges between the host computer system and the remote vendor stations, as well as the host's internal stations, are illustrated in FIG. 7. It is a question, notably:
of reports on the evolution of the buyer accounts of that vendor 702, regarding, for example, what buyer has paid on time or what buyer has not yet paid;
of guarantee requests 704 upstream from a buyer's order from a vendor,
statistical data 706.

All this must:
correspond exactly to the secured data introduced in the host computer system,
make it possible to determine a coherent state of things, in view of the different participants (vendors, buyers, host),
be able to be displayed/printed in a stable manner,
be able to be archived in as small a space as possible.

The first two points are important, but depend, of course, on the factor's know-how. It is to be noted that the corresponding controls are applied in parallel and that the result of each of those controls can arrive in a totally asynchronous manner in relation to the moment when the host decides to “set” a coherent state for itself or for one or more vendors. As so described, the problem becomes one of:
accumulating data in non-ordered fashion,
being able to display/print them in stable manner;
being able to archive them in as small a space as possible.

It will now be described how that problem was solved from a base file referred to here as a “native file” or “generic file.”

FIG. 7 shows the elaboration of a native file described below.

Various pieces of information are required in order to elaborate a native file associated with a vendor: the evolution of the buyers' accounts 702 for that vendor, the guarantee requests 704 of that vendor, the statistical data 706 relating to the information concerning that vendor and other information stored in a memory 700. Each of those pieces of information is processed by a server 10 in the form of an information flow 720, 740 and 760, respectively. Other information flows can be taken into account and are consultable from a memory 710. Other appropriate processes, in batch, for example, make it possible to process those information flows in order to construct a native file (600) for that vendor. The resulting files can be addressed to the vendor through the Factonet DLL application 41 of FIG. 4 in one of the ways described.

In the example, the native file is a record file (lines or rows) of fixed length. It comprises:
a head record, the structure of which is given in the attached Table 1;
a variable number of useful records (“body”), the structure of which is given in the attached Table 2; and
an end record, the structure of which is given in the attached Table 3.

For the body, each row comprises:
a second account identifier vend_id,
a document type identifier (of display/printing) Doc_type,
information for presentation in the document, here:
a page number PageNoInDoc
a front-back choice PrintSide
position information Data_pos
printing attributes information PrintAttrib
line jump information LineJump
information pointers on graphic elements to be inserted Graph_elmts
a filling area filler, and
a data area (of display/printing) Data_content

The body can also contain a row defining a first identifier of the factoring company soc_id.

In the example, the data to be displayed/printed can be defined:
by the area Data_content, a character string, and/or
by a pointer to another data element, for example, graphic, like Graph_elmts.

The value of Data_content can be of character type, implicit by convention. In that case, the other types of data to be printed can be converted into characters in order to be thus noted in Data_content. As a variant, Data_content can also contain, at head, for example, a code defining the type of data contained each time in the Data_content area.

If this is desired, the other types of data can also be defined through a pointer stored in Data_content.

Applicant has observed that this structure is quite simple for securely housing large quantities of display/printing data, arriving in a mixed stream as to the document referred to, as to time and even as to different parts of a same document.

Such a file, created in a stream, covers a priori a plurality of vendors.

It is bordered at the head by a starting record (Table 1) containing here the following useful information:
a date of file creation Creat_Date
an effective date of the file Effect_Date
file class information File_class, for example, the Monthly Management Statement (RMG) class defining a set of documents addressed to the vendors, and the Buyer Notification Statement (RNA) class defining another set of documents, addressed this time to the buyers.

The starting record also optionally contains:
soc_id, already mentioned.

The end record (Table 3) is similar to the starting record. In the example, the file data and class information is replaced by a number of records NbO/Rec.

There remains the head area of each record rec_code, which equals 1 for the head record, 9 for the end record and, for the body records, a value ranging from 2 to 4, in order to indicate (in the example) whether the record concerned is intended for display, for printing or for both (values 5 to 8 are reserved).

It is to be observed that the native file can theoretically contain up to 100 million records (10⁸), which, for 241 record characters, would give it a size of approximately 24.1 Gigaoctets. In practice, Applicant tested a file of approximately 500 Megaoctets, covering more than one thousand vendors.

One of the tasks of factors is to produce a “monthly management statement,” which must be sent to their customers, the vendors, for consultation, printing and/or archiving. This example of the “monthly management statement” is now considered.

The monthly management statement is defined by a set of documents sent to the vendor and comprising, for example:
the guarantee lines allocated to the vendor,
the current account of the vendor,
the subrogated invoices which are “by way of exception” the invoices in arrears, for example.

The vendor can simply apply for a guarantee, manage the invoices itself and make use of the monthly management statement in order to detect, notably, the invoices in arrears. That monthly management statement can be elaborated from a native file.

FIG. 6 uses a native file 600, elaborated, for example, as indicated above. The input stream feeding the native file is under the control here of a native file manager 602.

Thus, according to another aspect of the invention, a generator of a native printing file is provided, with authentic font printing, drawn from a coherent set of data present in the internal server, and a document manager capable of printing account-oriented data (vendors) from that native file in different formats.

The native file (or generic file) 600 can serve for different kinds of display/printing, with the aid of a tool for access (“accessor”) to this file 605, which will be referred to here as an extractor.

The simplest use of the native file is the preparation of individual monthly management statements for all the vendors.

In a known manner, the extractor is set up as a function which receives one or more of the filtering conditions applicable to body (or line) records of the native file. In response, that function is capable of isolating all the lines of the native file verifying the filtering condition or conditions. In the case of printing, filtering will be further limited to the lines, the rec_code of which is 3 or 4; this can be defmed by the nature of the request.

The function also preferably uses one or more sorting criteria, which can be predefined or received by the function as second parameters (in addition to the first parameter constituting the filtering conditions).

A predefined sorting condition of particular interest is:
primary sorting by vendor (vend_id),
secondary sorting by position in the document, namely, in principle in the order:
page number PageNoInDoc
front-back choice PrintSide
position information Data_pos, and
other position data drawn possibly from graphic elements to be inserted Graph_elmts, from LineJump information and from the effective length of the useful data field Data_content.

Of course, more specific requests can also be made, for example, if a host's internal station wishes to display what concerns a specific vendor.

In brief, in order to display/print a state, the computer system has only to supply a request, processed by the requester 607. It can then supply the data corresponding to the request. The latter can cover only the Doc_type area, as already described, for sake of simplification. In practice, Doc_type is only an identifier of document type, such as a “monthly management statement,” which can be of general scope, but can be broken down into as many target files as there are vendors processed.

On the other hand, if one is limited to a given vendor, the data to be displayed/printed are completely determined only by a doublet (vend_id, Doc_type).

Additional selection criteria can be used after the first selection on Doc_type, or else at the same time as the latter. Indexes can be used to accelerate the work of the extractor 605.

In the example, FIG. 6 shows three constructors of display/printing files in different formats.

Constructor 610 elaborates files here, such as “PDF,” ensuring a stable presentation practically whatever the printing (and/or display) peripheral. This can constitute files of reasonable size, compatible with a rapid transmission to the “vendor” by the Internet. As a variant, for “major account” vendors, it would be conceivable to send them the extract of the generic file concerning them, while constructor 610 would be implanted in the vendor's computer system.

Constructor 620 elaborates image files here, such as “tiff,” ensuring a stable and convenient display, practically whatever the display peripheral, for the host's personnel using the screens full time. The creation of image files, for example “tiff,” from the generic file is considered accessible to the expert.

Constructor 630 elaborates files here, such as in the VIPP format (Variable Data Intelligent Postscript Printware), compatible with stable and high-quality printing, which can be subcontracted. Speed here is not vital, taking into account the time required for the printing which is going to follow.

It is important to emphasize that all this can be done at any time, on the basis of a native file that is simple and, therefore, easy to archive.

FIG. 9 illustrates an embodiment of reading of a native file by a display/printing file constructor.

The input file to be read is first opened at 810 and the reading of this file begins at 812. In this example, the fact that the input file can actually serve as native file (for processing by the file constructor concerned) is indicated by a variable codenr set at “1.” The process is therefore ended at 830 if the variable codenr is different from 1. This variable codenr reflects the code “1” (rec_code) contained in the head record of a native file. If the variable codenr is equal to 1, the procedure is continued in operation 816.

It is recalled that the code File_class of the heading of the native file plants the document in a particular class. The set of possible document classes can be stored in a table, noted “Tabl24,” which also defines what types of printing are provided for each class of documents. Operation 813 inspects this table “Tabl24” in order to determine whether the native input file is cut out to be processed by the display/printing file constructor considered (here, one of constructors 610, 620 and 630). If this is not the case (818), the process ends at 830.

If, on the other hand, the table Tabl24 accepts at 818 the document class of the native file at 818 for the display/printing file constructor considered, reading of the native file continues at 820, as long as the end of the file is not reached (test 822).

In principle, in a pass, only the records relating to a given vendor (code vend_id) are considered.

On each reading step, the value of the record code rec_code is examined at 824, in order to determine whether it corresponds to the constructor concerned. Here a rec_code 2 or 4 authorizes the constructors of files 610 and 630; a rec_code 3 or 4 authorizes the constructor of image file 620.

The value of code Doc_Type is also examined at 824, so as to establish the “dossier” limits in the file.

Where the desired codes are found at 824, the formatting for printing can be done at 826. This formatting will be described below.

Reading of the native file then continues at 820 up to a new record code which has editing value at 824 and until the end of the file at 822. As soon as the native file is entirely covered, the number of dossiers formatted from the native file can be posted at 828. The process ends at stage 830.

In case of the elaboration of a file in PDF format from a native file, as described above, formatting consists a priori of creating the specific heading of a PDF file. Each passage to operation 826 can be made by generating, from areas useful for printing the record of the native file concerned, the parameters desired for a call of a trade tool like the “Adobe PDFwriter”. Thus, Applicant was able to write under DELPHI (Borland) a module called “rasterPDF.exe” based on the flow chart of FIG. 9.

In the case of elaboration of a file in the VIPP format from a native file, formatting consists mainly of writing different declarations, which are a function of the data of the native file and of the context.

In the case of the VIPP format, writing a declaration consists of writing a declared object in the file, then writing the general attributes concerning this object and writing the end of this declaration.

Thus, formatting proper introduces a heading declaration (called XRX) for editing in VIPP format, followed by the general attributes of editing, and then an “end of XRX declaration.”

Other types of declarations can be written, notably for:
the START of the file in VIPP format,
what pertains to the native code,
the orientation of the paper.
front/back printing or not,
the printing margins.

When breaks are detected, different measures are taken, depending on the nature of the break and the context.

Thus, when a document type break is encountered:
a table of signaletic data of the document is read,
declarations of type of “sheet feed attachment to be used” are written,
declarations of the start of front and back page editing are written,
checks of fonts and logos to be used are made.

When a page change is detected:
a check is made for a possible change of sheet feed attachment,
declarations of page change codes are written.

When a data change is detected:
a table of data characteristics is read,
declarations of alignment are written, if the paragraph is justified,
declarations of data display/printing coordinates are written.

Other entries of declarations are available, notably, in order to declare a number of lines of spacing and, on reading of a table of font characteristics, to declare the name of the font, its size, interline spacing and underlining, if need be.

Other possible operations consist of the transformation of certain characters (those used as command in the VIPP format), or even of the writing of declarations of type of alignment in the case of a new paragraph.

In the case of a graphic element:
the characteristics of the graphic element are read in a table,
the declarations of the native file data are written.

The file ends with declarations of end of editing in the VIPP format.

It is now possible to summarize the application of the invention to factoring.

One who has entered into a general factoring contract with the factor is considered a “vendor.”

The vendor can then delegate to an accounting operator entry of the invoices to be delegated to the factor. This entry is made directly from a remote station on a wide-area network like the Internet. After identification of the operator and, therefore, of the vendor, a single token is used to obtain a secure online entry at the same time between operators of different vendors and in the event of possible transmission breaks or errors.

At the end of entry, the invoices entered are assigned on line to the factor by a qualified representative of the vendor. In order to have a legally valid character, this assignment of invoices is accompanied by an electronic certification, on the basis, for example, of PKI public keys, defined by a third party of confidence. If legal considerations warrant additional proof, a printed version of the invoices entered is made and returned duly signed to the factor. Printing can be done immediately on the basis of the information entered on the vendor's side, as well as on the basis of a return of file to be printed from the factor to the vendor.

The factor can then carry out the mission delegated to him, namely, collecting invoices from the buyers and renewing them, if necessary.

The vendor can also ask the factor:
to guarantee payment of invoices pending, and/or
to grant it a credit on the basis of payments of invoices pending.

These requests are made with the same security and the same validity as the entry of invoices on line.

Thus, the invention makes it possible to carry out on line, over a wide-area and therefore open network, the entry of large-sized documents having legal value between the parties securely and certifiably.

A close match can be obtained, furthermore, between the version entered on the screen and the accompanying paper version.

The vendor's operator can then always consult his account or accounts on the screen and at his remote station.

The factor must deliver accounting documents to the vendor systematically and/or periodically. Furthermore, the factor's personnel manage the vendors' accounts and are available to the vendors to answer their questions on line. The use of the internal native files at the factor's has been described. They make it possible to establish several versions of the same document printed or displayed, while enabling presentation of the contents in the different versions to be identical or very close. This considerably contributes to facilitating the work and long-distance communication between the vendors and the factor's personnel.

Thus, the means described make possible a considerable advance in remote processing of factoring. The costs of computerization as well as of management of accounts, at the level of reports and dialogue with vendors, can thus be limited as much as possible.

On remote interaction, the operations performed by the system can be as follows:
verifying identification of the vendor,
starting a vendor session by creation of a vendor object and of a single token allocated to that vendor object, the token identifying the progress of the vendor session and the vendor object containing the count of the session up to the current state of progress,
in response to an entry request from the vendor associated with the token, returning from the server an entry form associated with the token,
recording the entered information received on return with the token,
verifying the validation of that information by the vendor, and then certification through a personal code (PIN) of an entity authorized to certify for that vendor,
if need be, generating a printing file provided to be returned as document signed by the vendor.

On the side of the factoring server (outward), that can involve the following elements:
a function of identification of a vendor on reception of a vendor identifier,
a first creation function, for creating a vendor function, with a vendor identifier,
a second creation function, for creating a single token,
a function of allocation of a token created for a vendor object, a vendor object to which a token defining a vendor session is allocated,
a container for storing each vendor object and its allocated token,
a vendor identifier search function in the vendor objects of the container,
an exchange function between at least the service provider and the vendor station or stations in order to use the token on information exchanges during the vendor session, the token making it possible to establish the current state of the session.

The service provider is set up to call the identification function, the second creation function and the search function on demand of a vendor in order to open a vendor session, then to call either the first creation function and the allocation function or the allocation function alone depending, notably, on the result of the search function, and, finally, to call the exchange function.

1. Computer system, comprising:
a network interface, capable of initializing a connection with a remote station,
a memory manager, capable of creating and maintaining a memory space dedicated to a remote station, for the exchange of data between the system and that remote station, and
a session manager, reacting to a connection initialization with successful identification by opening a remote station session, associated with a single token and a memory space dedicated to the remote station in the memory manager,
the data exchanges with the remote station in the course of a session being conditioned by the presence of the associated token.

2. Computer system according to claim 1, characterized in that the memory manager is set up to define the said memory space dedicated as software object, associated with the identifier and with the single token.

3. Computer system according to claim 2, characterized in that it includes a container capable of storing a correspondence between software objects and the single tokens assigned to them.

4. Computer system according to claim 3, characterized in that the session manager is set up, after successful identification, to retrieve a software object corresponding to that identification and, if it exists, to offer the remote station, as first exchange with token, the option of resuming a task on that software object or of abandoning it in order to create a new one associated with a new task.

5. Computer system according to claim 1, characterized in that the single token is obtained by concatenation of the result of a random function on the current date, current time and a random value.

6. Computer system according to claim 1, characterized in that the vendor's session manager is set up to offer a remote station a data entry function, an entered data validation function and at least one post-processing function after validated entry.

7. Computer system according to claim 1, characterized in that it includes a remote entry application, offered to the remote station, the dedicated memory space being allocated to the temporary storage of entered data awaiting validation.

8. Computer system according to claim 7, characterized in that the data entered are invoice data submitted remotely to a factoring entity by a remote vendor station.

9. Computer system according to claim 8, characterized in that the session manager is set up to offer a remote vendor station an invoice entry function, an entered invoice validation function for submission to factoring, a credit approval application function on invoices submitted to factoring and an account consulting function at the factor's.

10. Computer system according to claim 9, characterized in that in invoice entry mode the session manager operates by sending the remote station an entry form, with wait for a return of the completed form, accompanied each time by the corresponding single token.

11. Computer system according to claim 9, characterized in that the session manager is set up at least to make the function of validation of invoices entered for submission to factoring subject to a certification based on a personal code (PIN) by the qualified operator on the vendor side.

12. Computer system according to claim 9, set up as an exchange server cooperating with an internal server, characterized in that the exchange server is set up to transmit the validated entries to the internal server, which ensures the keeping of accounts and related operations selectively for each vendor entity.

13. Computer system according to claim 12, characterized in that final validation is dependent on the sending of another document signed by the vendor via a means other than the wide-area network.

14. Computer system according to claim 12, characterized in that the session manager is set up also to offer a remote vendor station a guarantee application function on entered invoices.

15. Computer system according to claim 12, characterized in that it includes a generator of a native printing file, with authentic font printing, drawn from a coherent set of data present in the internal server, and a document manager capable of printing account-oriented data from that native file in different formats.

16. Computer system according to claim 15, characterized in that the document manager comprises:
a native file accessor, capable of reacting to a document identifier by selecting a corresponding portion of the native file, and
at least two printing/display constructors, capable of cooperating with the native file accessor in order to construct two display/printing files, corresponding to the same printable content, those two display/printing constructors operating on different file formats,
which makes it possible to use, internally and at the vendors, documents directly comparable, printed and/or on the screen.

17. Computer system according to claim 16, characterized in that the display/printing constructors include a display/printing constructor operating in PDF format.

18. Computer system according to claim 16, characterized in that the display/printing constructors include a display/printing constructor operating in image file format.

19. Computer system according to claim 16, characterized in that the display/printing constructors include a display/printing constructor operating in an exchange file format, capable of being transmitted for mass printing.

20. Computer system, including a factoring server, capable of managing vendor accounts established on the basis of invoices sent by each vendor to the factor, in accordance with collections of invoices from buyers, in a manner known per se, as well as an outward applications server, for remote stations,
characterized in that the outward applications server is set up to work in a wide-area network with one or more remote vendor stations and to respond to a vendor identifier for an information entry request, by operating a request processing application, involving:
verifying identification of the vendor,
starting a vendor session by creation of a vendor object and of a single token allocated to that vendor object, the token identifying the progress of the vendor session and the vendor object containing the count of the session up to the current state of progress,
sending an entry application from the vendor associated with the token to a response server capable of returning the entry form associated with the token,
recording the entered information received on return with the token,
verifying the validation of that information by the vendor, and then certification through a personal code (PIN) of an entity authorized to certify for that vendor.

21. Computer system according to claim 20, characterized in that the said request processing application is further capable
of generating a printing file provided to be returned as document signed by the vendor.

22. Computer system, including a factoring services provider interconnected on a wide-area network with one or more vendor stations, characterized in that the factoring services provider embraces
a function of identification of a vendor on reception of a vendor identifier,
a first function of creation of a vendor object, a vendor object including a vendor identifier,
a second function of creation of a single token,
a function of allocation of a token created for a vendor object, a vendor object to which a token defining a vendor session is allocated,
a container for storing each vendor object and its allocated token,
a vendor identifier search function in the vendor objects of the container,
an exchange function between at least the service provider and the vendor station or stations in order to use the token on information exchanges during the vendor session, the token making it possible to establish the current state of the session,
the service provider being capable of calling the identification function, the second creation function and the search function on demand of a vendor in order to open a vendor session, capable of calling either the first creation function and the allocation function or the allocation function alone depending at least on the result of the search function, and capable of also calling the exchange function.
